(19) United States
(12) Patent Application Publication
(10) Pub. No.: US 2025/0100168 A1
(43) Pub. Date: Mar. 27, 2025

(54) ROBOT, CONTROL METHOD OF ROBOT, RECORDING MEDIUM, METHOD FOR MANUFACTURING ARTICLE, DRIVE DEVICE, AND CONTROL METHOD OF DRIVE DEVICE

(71) Applicant: CANON KABUSHIKI KAISHA, Tokyo (JP)

(72) Inventor: JUNICHI FUKUDA, Kanagawa (JP)

(21) Appl. No.: 18/829,014

(22) Filed: Sep. 9, 2024

(30) Foreign Application Priority Data
Sep. 22, 2023 (JP) 2023-159240

(51) Int. Cl. B25J 19/00; B25J 13/08

(52) U.S. Cl. CPC B25J 19/0054; B25J 13/085; B25J 13/088

(57) ABSTRACT

A robot includes a first link, a second link, a motor configured to displace the second link with respect to the first link, a motor control unit configured to control the motor, a first heat dissipation member, a second heat dissipation member, a first heat conduction member configured to connect the motor control unit and the first heat dissipation member to each other, and a second heat conduction member configured to connect the motor and the second heat dissipation member to each other. The first heat conduction member and the second heat conduction member are separated from each other, and the first heat dissipation member and the second heat dissipation member are separated from each other.

### BACKGROUND OF THE INVENTION

### Field of the Invention

The present invention relates to heat dissipation in a robot or the like.

### Description of the Related Art

In recent years, the application of robots has been expanded, and the application of multi-joint robots has been expanded in fields requiring various operations such as work in cooperation with humans and assembly work in factories. Such a robot may use a control system in which a robot controller and a motor control device are connected to each other by a communication line or the like, and the motor control device controls a motor according to a control command transmitted from the robot controller.

Generally, in the robot, an inverter circuit inside the motor control device converts a direct current supplied from a power supply unit into an alternating current, and an AC motor provided in each joint is driven according to the alternating current. When the AC motor is driven, not only the AC motor itself generates heat, but a circuit in the motor control device also generates heat because a large current flows in the inverter circuit according to a load applied to the joint.

Japanese Unexamined Patent Application Publication No. 2020-25999 describes a robot arm having a configuration in which a substrate on which a drive circuit for driving an AC motor is mounted is brought into surface contact with a casing of the robot arm.

Japanese Unexamined Patent Application Publication (Translation of PCT Application) No. 2022-521440 describes, as a method for dissipating heat from a heat generating component inside a casing of a robot, a method in which a heat generating component is fixed to one thermally conductive bracket, and two heat sinks are brought into contact with the bracket to dissipate heat via two heat dissipation paths.

### SUMMARY OF THE INVENTION

According to a first aspect of the present invention, a robot includes a first link, a second link, a motor configured to displace the second link with respect to the first link, a motor control unit configured to control the motor, a first heat dissipation member, a second heat dissipation member, a first heat conduction member configured to connect the motor control unit and the first heat dissipation member to each other, and a second heat conduction member configured to connect the motor and the second heat dissipation member to each other. The first heat conduction member and the second heat conduction member are separated from each other, and the first heat dissipation member and the second heat dissipation member are separated from each other.

According to a second aspect of the present invention, a control method of a robot includes controlling a motor by a motor control unit. The robot includes a first link, a second link, the motor configured to displace the second link with respect to the first link, the motor control unit configured to control the motor, a first heat dissipation member, a second heat dissipation member, a first heat conduction member configured to connect the motor control unit and the first heat dissipation member to each other, and a second heat conduction member configured to connect the motor and the second heat dissipation member to each other. The first heat conduction member and the second heat conduction member are separated from each other, and the first heat dissipation member and the second heat dissipation member are separated from each other.

According to a third aspect of the present invention, a drive device for relatively displacing a first link and a second link includes a motor configured to displace the second link with respect to the first link, a motor control unit configured to control the motor, a first heat dissipation member, a second heat dissipation member, a first heat conduction member configured to connect the motor control unit and the first heat dissipation member to each other, and a second heat conduction member configured to connect the motor and the second heat dissipation member to each other. The first heat conduction member and the second heat conduction member are separated from each other, and the first heat dissipation member and the second heat dissipation member are separated from each other.

According to a fourth aspect of the present invention, a control method of a drive device for relatively displacing a first link and a second link includes controlling a motor by a motor control unit. The drive device includes the motor configured to displace the second link with respect to the first link, the motor control unit configured to control the motor, a first heat dissipation member, a second heat dissipation member, a first heat conduction member configured to connect the motor control unit and the first heat dissipation member to each other, and a second heat conduction member configured to connect the motor and the second heat dissipation member to each other. The first heat conduction member and the second heat conduction member are separated from each other, and the first heat dissipation member and the second heat dissipation member are separated from each other.

Further features of the present invention will become apparent from the following description of exemplary embodiments with reference to the attached drawings.

### BRIEF DESCRIPTION OF THE DRAWINGS

FIG. 1 is a schematic diagram illustrating a schematic configuration of a robot on which a joint mechanism is mounted according to an embodiment.

FIG. 2 is a schematic view for explaining a configuration of a robot arm included in the robot.

FIG. 3 is a schematic block diagram illustrating a configuration of a control system of the robot.

FIG. 4 is a cross-sectional view for explaining an internal structure of a joint mechanism according to a first embodiment.

FIG. 5 is an external perspective view of a joint mechanism according to a modification of the first embodiment.

FIG. 6 is a cross-sectional view for explaining an internal structure of a joint according to the modification of the first embodiment.

FIG. 7 is a cross-sectional view for explaining an internal structure of a joint mechanism according to a second embodiment.

FIG. 8 is a cross-sectional view for explaining an internal structure of a joint according to a first modification of the second embodiment.

FIG. 9 is a cross-sectional view for explaining an internal structure of a joint according to a second modification of the second embodiment.

FIG. 10 is a cross-sectional view for explaining an internal structure of a joint mechanism according to a third embodiment.

FIG. 11 is a cross-sectional view for explaining an internal structure of a joint mechanism according to a fourth embodiment.

FIG. 12 is a cross-sectional view for explaining an internal structure of a joint mechanism according to a fifth embodiment.

FIG. 13 is a cross-sectional view for explaining an internal structure of a joint mechanism according to a sixth embodiment.

### DESCRIPTION OF THE EMBODIMENTS

In a joint portion of a robot, a motor and a motor control device, both of which are heat generating elements, are installed relatively close to each other in a narrow space inside a casing. In a heat dissipation method proposed hitherto, a path for dissipating heat from one heat generating element has been studied, but a method for dissipating heat from two heat generating elements installed relatively close to each other such as a motor and a motor control device has not been sufficiently studied.

Motors and motor control devices, both of which are heat generating elements, often do not have the same heat resistance, and generally have different allowable maximum temperatures. In particular, when the temperature of the motor control device excessively rises, an electric circuit in the control device malfunctions, making it impossible to normally drive and control the motor and, the robot does not operate normally. For example, if the motor control device performs an abnormal operation and positive feedback is applied to the control in driving the motor, there is a possibility in the worst case scenario that the motor runs out of control and the robot itself or surrounding articles are destroyed.

Therefore, there has been a demand for a technique capable of appropriately dissipating heat from the motor and the motor control device even if the motor and the motor control device, both of which are heat generating elements, are installed relatively close to each other in the casing of the robot.

A joint mechanism, a robot, and the like according to embodiments of the present invention will be described with reference to the drawings. Note that the embodiments to be described below are exemplary, and for example, detailed configurations can be appropriately modified for implementation by those skilled in the art without departing from the gist of the present invention.

Meanwhile, it should be noted that, in the drawings referred to in the following description of embodiments, elements denoted by the same reference numerals have the same functions unless otherwise specified. In the drawings, in a case where a plurality of identical elements is arranged, the reference numerals and explanations thereof may be omitted.

In addition, since the drawings may be schematically represented for convenience of illustration and description, shapes, sizes, arrangements, and the like of elements shown in the drawings may not be exactly consistent with actual objects.

First, a robot on which a joint mechanism having a heat dissipation structure is mounted according to an embodiment will be described by way of example, and then a joint mechanism having a heat dissipation structure will be described in detail.

### Robot

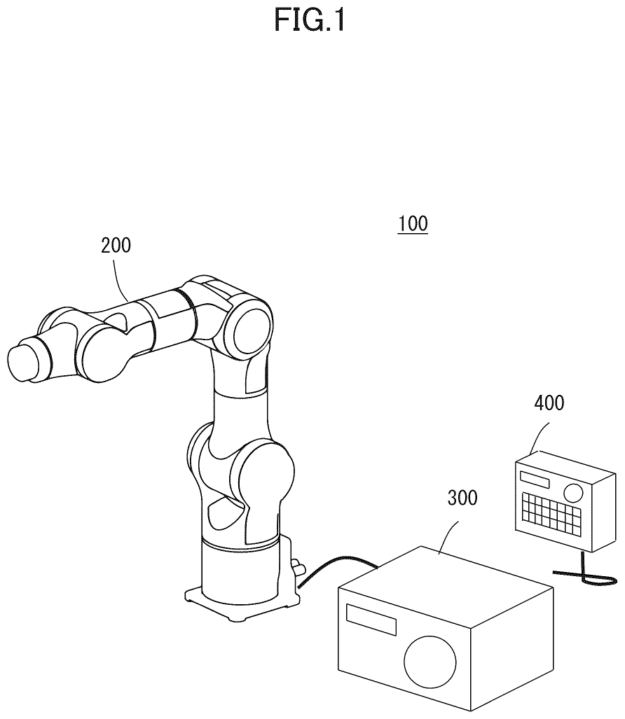

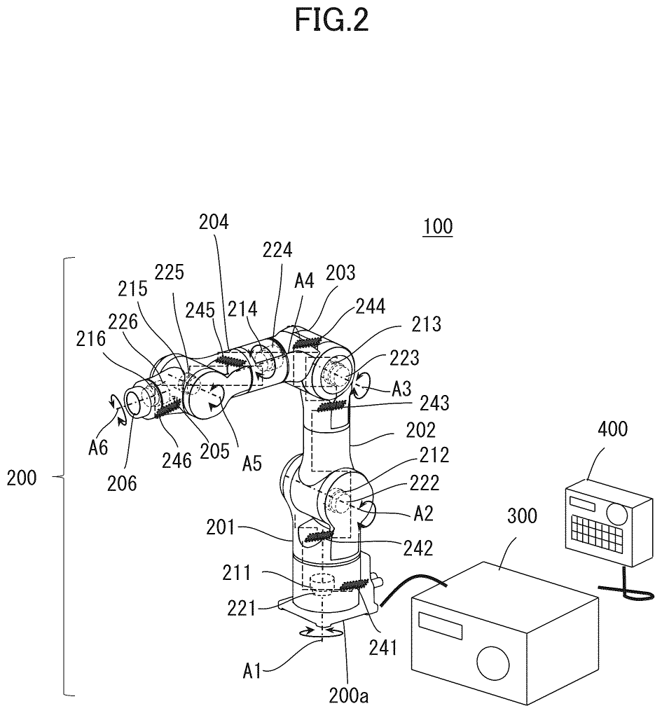

FIG. 1 is a schematic diagram illustrating a schematic configuration of a robot 100 according to an embodiment. A joint mechanism having a heat dissipation structure according to an embodiment is mounted on the robot 100. FIG. 2 is a schematic diagram for explaining a configuration of a robot arm 200 included in the robot 100.

The robot 100 exemplified in FIGS. 1 and 2 includes a robot arm 200 serving as a multi-joint robot, and a robot control device 300 that controls the robot arm 200. The robot 100 further includes a teaching pendant 400 serving as a teaching device that transmits data on a plurality of teaching points to the robot control device 300. The teaching pendant 400 is operated by an operator, and is used to designate the operations of the robot arm 200 and the robot control device 300.

The exemplified robot arm 200 is a six-axis control multi-joint robot. The robot arm 200 comprises links 201 to 206, and the links 201 to 206 are coupled to each other via joints 221 to 226. The joint 221 closest to a proximal end is fixed to a casing 200a of a proximal portion. Electric motors 211 to 216 for rotating (displacing) the links around rotation axes A1 to A6 are built in the joints 221 to 226. The electric motors 211 to 216 can be, for example, servomotors each including an encoder.

The joints 221 to 226 include motor control devices 241 to 246 serving as drive control units that control the drives of the electric motors 211 to 216. The motor control devices 241 to 246 output drive currents for controlling the electric motors 211 to 216, and independently control the operations of the electric motors 211 to 216.

The joints 221 to 226 include speed reducers (not illustrated) connected to the electric motors 211 to 216, and output units of the speed reducers are connected to the links driven by the respective speed reducers on output sides (terminal end sides). The joints 221 to 226 include angle sensors (not illustrated) that detect the angles of the output links, and torque sensors (not illustrated) that detect the torques for driving the output links.

An end effector (not illustrated) for performing predetermined work can be attached to a distal end of the link 206 of the robot arm 200. The end effector is selected according to the work performed by the robot 100. In a case where assembly work or movement work is performed in the production line, an end effector, e.g., an electric hand or an air hand driven by air pressure, is connected.

The teaching pendant 400 serving as an external input device has an operation unit including an operation key for teaching, for example, a posture (position or angle) of a joint of the robot arm 200 or a movement of a hand tip of the robot arm 200. When a certain operation is performed on the operation unit of the teaching pendant 400, the robot control device 300 controls the operation of the robot arm 200 by transmitting a signal to the motor control devices 241 to 246 disposed in the respective joints according to the operation.

With the above configuration, each link and/or the end effector can be moved to a certain position by the robot arm 200 to cause the robot to perform desired work. For example, using a predetermined workpiece and another workpiece as materials, a process of assembling the predetermined workpiece and the other workpiece is performed, whereby an assembled workpiece can be manufactured as a final product. Thus, an article can be manufactured by the robot arm 200. Note that the article manufacturing work performed using the robot arm 200 is not limited thereto. For example, an article can also be manufactured by providing a tool such as a cutting tool or a polishing tool on the robot arm 200 and processing a workpiece.

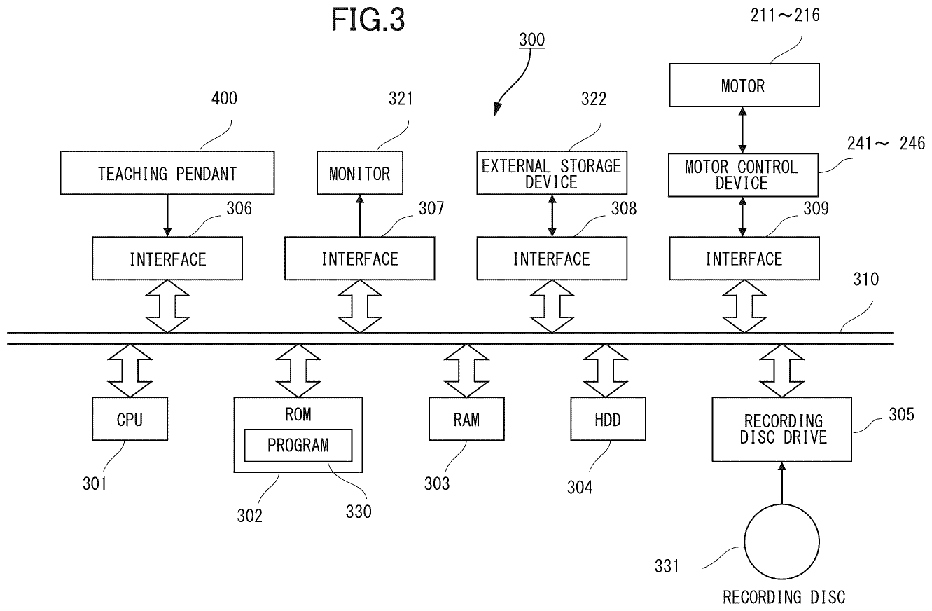

Next, a control system of the robot 100 will be described. FIG. 3 is a schematic block diagram illustrating a configuration of a control system of the robot 100. The robot control device 300 is constituted by a computer, and includes a central processing unit (CPU) 301. The robot control device 300 includes a read only memory (ROM) 302, a random access memory (RAM) 303, a hard disc drive (HDD) 304, and a recording disc drive 305 as a storage unit. In addition, the robot control device 300 includes interfaces 306 to 309 for communicating with the respective devices. The CPU 301, the ROM 302, the RAM 303, and the interfaces 306 to 309 are communicably connected to each other via a bus 310.

Among them, the RAM 303 is used to temporarily store data such as teaching points and control commands input by operating the teaching pendant 400. The ROM 302 stores a basic program 330 such as a BIOS for causing the CPU 301 to execute various kinds of arithmetic processing. The CPU 301 executes various kinds of arithmetic processing based on a control program recorded (stored) in the HDD 304. The HDD 304 can store various kinds of data or the like which are calculation processing results of the CPU 301. The recording disc drive 305 can read various kinds of data, control programs, and the like recorded in a recording disc 331. Furthermore, a monitor 321 on which various images are displayed and an external storage device 322 such as a rewritable nonvolatile memory or an external HDD are connected to the interfaces 307 and 308.

The teaching pendant 400 serving as an external input device may be another computer device (PC or server) capable of editing a robot program. The teaching pendant 400 serving as an external input device can be connected to the robot control device 300 via a wired or wireless communication connection unit, and has a user interface function for operating the robot and displaying a status. A target joint angle for each joint input by the teaching pendant 400 is output to the CPU 301 via the interface 306 and the bus 310.

For example, the CPU 301 receives teaching point data input by the teaching pendant 400 via the interface 306. Further, tracks of the respective axes of the robot arm 200 can be generated based on the teaching point data input from the teaching pendant 400, and can be transmitted to the motor control devices 241 to 246 via the interface 309. The CPU 301 outputs data on drive commands indicating control amounts of rotation angles of the motors of the respective joints to the motor control devices 241 to 246 via the bus 310 and the interface 309 at predetermined intervals.

The motor control devices 241 to 246 calculate amounts of currents to be output to the electric motors of the respective joints based on the drive commands received from the CPU 301, and supply the currents to the respective electric motors to control joint angles of the respective joints.

In addition, the CPU 301 acquires detection signals from angle sensors (not illustrated) that detect angles of the output links driven by the respective joints and torque sensors (not illustrated) that detect torques for driving the output links via the interface and the bus 310. The CPU 301 sends commands to the motor control devices 241 to 246 and feedback-controls the electric motors 211 to 216, so that the current values of the joint angles of the joints detected by the respective encoders become target joint angles. Alternatively, the CPU 301 sends commands to the motor control devices 241 to 246 and feedback-controls the electric motors 211 to 216, so that the torques detected by the respective torque sensors become target torques.

For example, when a robot hand is mounted as the end effector, the robot control device 300 can transmit a control signal to a motor control device (hand motor driver) of a motor that drives the hand via an interface (not illustrated). The hand motor driver calculates an amount of a current to be output to the hand motor based on the drive command received from the CPU 301, and supplies the current to the hand motor to control an operation of the hand motor. Further, the CPU 301 acquires a pulse signal from an encoder of the hand motor via the interface and the bus. That is, the CPU 301 feedback-controls the hand motor via the hand motor driver so that a current value of a speed of the hand motor detected by the encoder becomes a target speed.

The robot according to the embodiment on which the joint mechanism having the heat dissipation structure according to the present invention is mounted has been described above by way of example. Next, examples of a plurality of joint mechanisms each having a heat dissipation structure according to embodiments will be described.

### First Embodiment

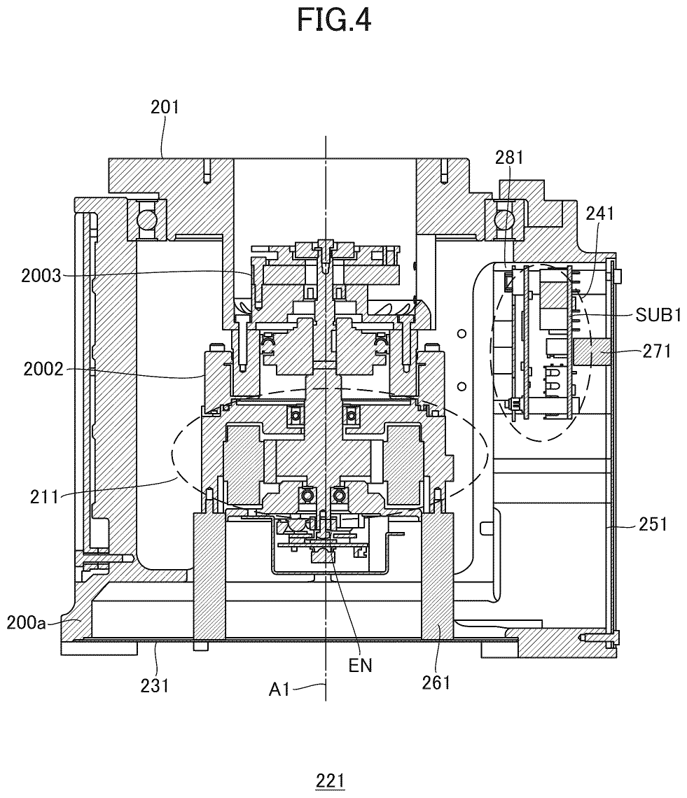

FIG. 4 is a cross-sectional view for explaining an internal structure of a joint 221 serving as a joint mechanism. The joint 221 is a joint closest to the proximal end as illustrated in FIG. 2, and the casing 200a of the proximal portion of the robot arm 200 and the link 201 are connected to each other by the joint 221.

The joint 221 supports the casing 200a and the link 201 at both ends by two bearings so that the link 201 is rotatable about the rotation axis A1. The joint 221 includes an electric motor 211 (e.g., a servomotor), a speed reducer 2002, a brake 2003, and a motor control device 241 (motor control unit), which are disposed in a space surrounded by a cover 251 and a cover 231. That is, in the internal space of the joint 221, the electric motor 211 and the motor control device 241, which are heat generating elements illustrated to be surrounded by dotted lines, are arranged relatively close to each other. The electric motor 211 is provided with an encoder EN that detects its rotation.

The motor control device 241 is fixed to the casing 200a via a fixing bracket 281, and includes a substrate SUB1 on which an electric circuit (control circuit) for controlling the drive of the electric motor 211 is mounted.

The casing 200a of the proximal portion has an opening enabling the motor control device 241 to be attachable/detachable, and the cover 251, which is attachable/detachable, is attached to the casing 200a so as to cover the opening. The casing 200a of the proximal portion also has an opening enabling the electric motor 211, the speed reducer 2002, or the brake 2003 to be attachable/detachable, and the cover 231, which is attachable/detachable, is attached to the casing 200a so as to cover the opening.

The electric motor 211 and the motor control device 241, which are heat generating elements, need to be provided with a heat dissipation unit. As will be described below, the present embodiment is characterized by the configurations of the heat dissipation paths for the electric motor 211 and the motor control device 241.

The electric motor 211, which works to rotate the robot arm closer to the distal end than the link 201, generates a large amount of heat when a large load is applied thereto, and a large amount of heat is discharged to the heat dissipation path for the electric motor 211.

On the other hand, when the temperature of the motor control device 241 rises excessively, the electric circuit (control circuit) malfunctions, and the electric motor 211 cannot be controlled to be normally driven. Therefore, the heat dissipation unit for the motor control device 241 is required to be able to stably discharge heat.

Generally, the heat dissipation paths are formed of members having good thermal conductivity. For example, when the member of the heat dissipation path for the motor control device 241 and the member of the heat dissipation path for the electric motor 211 are in contact with each other, or when the heat dissipation paths are formed by sharing the same member, heat conduction occurs between the heat dissipation paths.

If the heat dissipation path for the motor control device 241 and the heat dissipation path for the electric motor 211 are configured to easily conduct heat therebetween, the function of dissipating heat from the motor control device 241 may be affected by heat dissipation from the electric motor 211. When a large amount of heat is discharged from the electric motor 211 to the heat dissipation path and the temperature of the member constituting the heat dissipation path rises, the amount of heat discharged from the heat dissipation path for the motor control device 241 decreases, or in a certain case, some of the heat generated by the electric motor 211 is conducted to the motor control device 241. Then, the function of dissipating heat from the motor control device 241 decreases, and the temperature of the motor control device 241 rises, which increases the possibility that the electric circuit (control circuit) malfunctions.

In the present embodiment, a structure for making it difficult to conduct heat between the heat dissipation paths is adopted while the heat dissipation path for the motor control device 241 and the heat dissipation path for the electric motor 211 are individually formed by using members having good thermal conductivity.

That is, the substrate SUB1 on which the electric circuit (control circuit) in the motor control device 241 is mounted is connected to the cover 251 (first heat dissipation member) via a heat conduction member 271 (first heat conduction member) serving as a first heat dissipation path. Heat generated by the electric circuit (control circuit) on the substrate SUB1 is dissipated from the cover 251 to the atmosphere. In order to bring the substrate SUB1 and the heat conduction member 271 into contact with each other over a wide area without short-circuiting the electric circuit (control circuit) in the substrate SUB1, the substrate SUB1 and the heat conduction member 271 may be disposed with a heat conduction sheet interposed therebetween, the heat conduction sheet being electrically insulating but providing good thermal conductivity.

In addition, the electric motor 211 is connected to the cover 231 (second heat dissipation member) via a heat conduction member 261 (second heat conduction member) serving as a second heat dissipation path. The heat generated by the electric motor 211 is dissipated from the cover 231 to the atmosphere. For example, a housing (exterior member) on the stator side of the electric motor 211 and the heat conduction member 261 may be connected to each other over a wide area.

For the casing 200a of the proximal portion, the housing of the electric motor 211, the heat conduction member 261, the heat conduction member 271, the fixing bracket 281, the cover 231, and the cover 251, for example, members made of an aluminum alloy, which is lightweight, can be used, but the members are not limited thereto. Members made of another metal, e.g., a magnesium alloy or an iron alloy, may be used. The heat conduction member 261 and the heat conduction member 271 may be made of a metal having high thermal conductivity, such as copper, or a polymer material.

As described above, in the present embodiment, since the heat conduction member 271 for the first heat dissipation path and the heat conduction member 261 for the second heat dissipation path are separate members disposed apart from each other, heat generated by the electric motor 211 is not directly conducted from the second heat dissipation path to the first heat dissipation path.

Furthermore, it is preferable to employ a configuration in which heat conducted from the electric motor 211 to the cover 231 via the heat conduction member 261 is suppressed from being transmitted to the motor control device 241 via the casing 200a of the proximal portion. Specifically, the fixing bracket 281 can be made of a material having low thermal conductivity (e.g., a resin material). Alternatively, for example, a metal material is used for the fixing bracket 281, and a resin member or a ceramic member having low thermal conductivity may be interposed at a connection portion between the fixing bracket 281 and the casing 200a of the proximal portion to suppress heat conduction from the casing 200a of the proximal portion to the fixing bracket 281. Alternatively, for example, a metal material is used for the fixing bracket 281, but a resin member or a ceramic member having low thermal conductivity may be interposed between the fixing bracket 281 and the motor control device 241.

In addition, a resin member or a ceramic member having low thermal conductivity may be interposed at a connection portion between the cover 231 and the casing 200a of the proximal portion, or a resin member or a ceramic member having low thermal conductivity may be interposed at a connection portion between the cover 251 and the casing 200a of the proximal portion.

In the present embodiment, the cover 251, which is an attachable/detachable outer cover disposed at a position not intersecting the rotation axis A1 of the joint, is used as a first heat dissipation member, and the attachable/detachable cover 231 disposed in a direction intersecting the rotation axis A1 is used as a second heat dissipation member. The motor control device 241 and the first heat dissipation part are connected to each other by the first heat dissipation path (heat conduction member 271), and the electric motor 211 and the second heat dissipation member are connected to each other by the second heat dissipation path (heat conduction member 261).

As described above, since a structure for making it difficult to conduct heat between the heat dissipation paths is adopted by individually forming the heat dissipation path for the motor control device 241 and the heat dissipation path for the electric motor 211, heat discharged from the electric motor 211 is prevented from affecting the function of the motor control device 241. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### Modification of First Embodiment

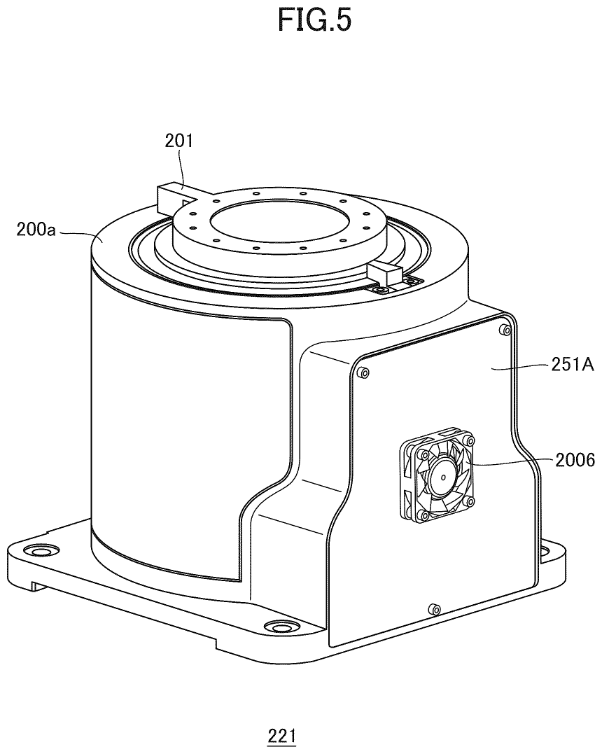

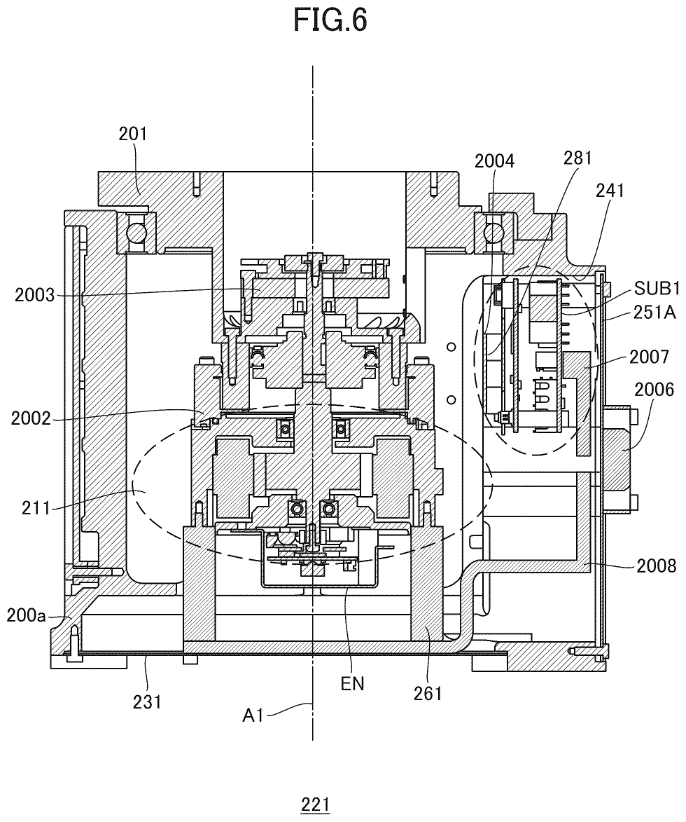

A modification of the joint 221 according to the first embodiment will be described. FIG. 5 is an external perspective view of the joint 221 according to the modification, and FIG. 6 is a cross-sectional view for explaining an internal structure of the joint 221 according to the modification. The description of elements and matters similar to those in the first embodiment will be simplified or omitted.

Similarly to the first embodiment illustrated in FIG. 4, in the modification as well, a structure for making it difficult to conduct heat between the heat dissipation paths is adopted while the heat dissipation path for the motor control device 241 and the heat dissipation path for the electric motor 211 are individually formed. However, the modification is different from the first embodiment in that heat pipes connected to the heat conduction members and an air cooling fan that cools the heat pipe by sending an air flow to the heat pipe are provided.

The substrate SUB1 of the motor control device 241 (motor control unit) is disposed to be parallel to the rotation axis A1, and is connected to the casing 200a of the proximal portion via the fixing bracket 281. A heat insulating member 2004 is disposed between the fixing bracket 281 and the casing 200a.

An opening is provided on one side of the casing 200a of the proximal portion to enable the substrate SUB1 of the motor control device 241 to be attachable/detachable, and the opening is covered with an attachable/detachable cover 251A. The cover 251A has an opening that allows the internal space and the external space of the joint 221 to communicate with each other, and an air cooling fan 2006 is attached to the opening.

In the modification, a heat pipe 2008 is attached to the heat conduction member 261 in surface contact with the housing of the electric motor 211, and a heat pipe 2007 is attached to the heat conduction member 271 in surface contact with the substrate SUB1 of the motor control device 241. The heat pipe 2007 may be brought into contact with the substrate SUB1.

By driving the air cooling fan 2006, external air can be blown to the heat pipe 2008 and the heat pipe 2007 to enhance heat dissipation efficiency. The air cooling fan 2006 may be driven in a direction in which air in the vicinity of the heat pipe 2008 and the heat pipe 2007 is sucked to the outside. In the present embodiment, air is blown using the single air cooling fan 2006 to air-cool the heat pipe 2008 and the heat pipe 2007, but air cooling fans may be individually disposed in the respective heat pipes. Alternatively, air may be directly blown to the first heat conduction member and/or the second heat conduction member by using air cooling fans without inducing heat by the heat pipes.

As described above, since a structure for making it difficult to conduct heat between the heat dissipation paths is adopted by individually forming the heat dissipation path for the motor control device 241 and the heat dissipation path for the electric motor 211, heat discharged from the electric motor 211 is prevented from affecting the function of the motor control device 241. Furthermore, in the modification, the air cooling fan is provided to enhance efficiency in dissipating heat from the heat dissipation path. Therefore, in the present modification as well, even when the motor and the motor control device, which are heat generating elements, are installed relatively close to each other in the casing of the robot, heat can be appropriately dissipated from the motor and the motor control device, and the robot can be stably operated.

### Second Embodiment

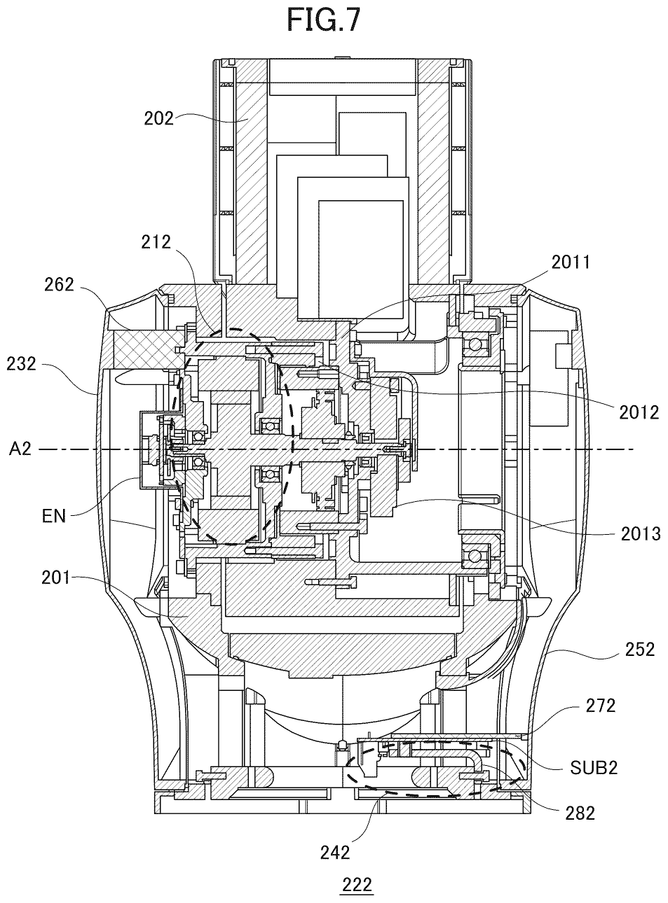

FIG. 7 is a cross-sectional view for explaining an internal structure of the joint 222 serving as a joint mechanism. The joint 222 is a joint second closest to the proximal end as illustrated in FIG. 2, and connects the link 201 and the link 202 of the robot arm 200.

The joint 222 support the link 201 and the link 202 at both ends by two bearings so that the link 202 is rotatable about the rotation axis A2. The link 202 is connected to an output side of a speed reducer 2012 via a connection member 2011, and the link 202 rotates about the rotation axis A2 with respect to the link 201 by rotating the electric motor 212. The electric motor 212 is provided with an encoder EN that detects its rotation.

The joint 222 includes an electric motor 212 (e.g., a servomotor), a speed reducer 2012, a brake 2013, and a motor control device 242, which are disposed in a space surrounded by a cover 252 and a cover 232. That is, in the internal space of the joint 222, the electric motor 212 and the motor control device 242, which are heat generating elements illustrated to be surrounded by dotted lines, are arranged relatively close to each other.

The motor control device 242 (motor control unit) is fixed to the link 201 via a fixing bracket 282, and includes a substrate SUB2 on which an electric circuit (control circuit) for controlling the drive of the electric motor 212 is mounted.

The electric motor 212 and the motor control device 242, which are heat generating elements, need to be provided with a heat dissipation unit. As will be described below, the present embodiment is characterized by the configurations of the heat dissipation paths for the electric motor 212 and the motor control device 242.

The electric motor 212, which works to rotate the robot arm closer to the distal end than the link 202, generates a large amount of heat when a large load is applied thereto, and a large amount of heat is discharged to the heat dissipation path for the electric motor 212.

On the other hand, when the temperature of the motor control device 242 rises excessively, the electric circuit (control circuit) malfunctions, and the electric motor 212 cannot be controlled to be normally driven. Therefore, the heat dissipation unit for the motor control device 242 is required to be able to stably discharge heat.

Generally, the heat dissipation paths are formed of members having good thermal conductivity. For example, when the member of the heat dissipation path for the motor control device 242 and the member of the heat dissipation path for the electric motor 212 are in contact with each other, or when the heat dissipation paths are formed by sharing the same member, heat conduction occurs between the heat dissipation paths.

If the heat dissipation path for the motor control device 242 and the heat dissipation path for the electric motor 212 are configured to easily conduct heat therebetween, the function of dissipating heat from the motor control device 242 may be affected by heat dissipation from the electric motor 212. When a large amount of heat is discharged from the electric motor 212 to the heat dissipation path and the temperature of the member constituting the heat dissipation path rises, the amount of heat discharged from the heat dissipation path for the motor control device 242 decreases, or in a certain case, some of the heat generated by the electric motor 212 is conducted to the motor control device 242. Then, the function of dissipating heat from the motor control device 242 decreases, and the temperature of the motor control device 242 rises, which increases the possibility that the electric circuit (control circuit) malfunctions.

In the present embodiment, a structure for making it difficult to conduct heat between the heat dissipation paths is adopted while the heat dissipation path for the motor control device 242 and the heat dissipation path for the electric motor 212 are individually formed by using members having good thermal conductivity.

That is, the substrate SUB2 on which the electric circuit (control circuit) in the motor control device 242 is mounted is connected to the cover 252 (first heat dissipation member) via a heat conduction member 272 (first heat conduction member) serving as a first heat dissipation path. Heat generated by the electric circuit (control circuit) on the substrate SUB2 is dissipated from the cover 252 to the atmosphere. In order to bring the substrate SUB2 and the heat conduction member 272 into contact with each other over a wide area without short-circuiting the electric circuit (control circuit) in the substrate SUB2, the substrate SUB2 and the heat conduction member 272 may be disposed with a heat conduction sheet interposed therebetween, the heat conduction sheet being electrically insulating but providing good thermal conductivity.

In addition, the electric motor 212 is connected to the cover 232 (second heat dissipation member) via a heat conduction member 262 (second heat conduction member) serving as a second heat dissipation path. The heat generated by the electric motor 212 is dissipated from the cover 232 to the atmosphere. For example, a housing (exterior member) on the stator side of the electric motor 212 and the heat conduction member 262 may be connected to each other over a wide area.

For the link 201, the housing of the electric motor 212, the heat conduction member 262, the heat conduction member 272, the fixing bracket 282, the cover 232, and the cover 252, for example, members made of an aluminum alloy, which is lightweight, can be used, but the members are not limited thereto. Members made of another metal, e.g., a magnesium alloy or an iron alloy, may be used. The heat conduction member 262 and the heat conduction member 272 may be made of a metal having high thermal conductivity, such as copper, or a polymer material.

As described above, in the present embodiment, since the heat conduction member 272 for the first heat dissipation path and the heat conduction member 262 for the second heat dissipation path are separate members disposed apart from each other, heat generated by the electric motor 212 is not directly conducted from the second heat dissipation path to the first heat dissipation path.

Furthermore, it is preferable to employ a configuration in which heat conducted from the electric motor 212 to the cover 232 via the heat conduction member 262 is suppressed from being transmitted to the motor control device 242 via the link 201. Specifically, the fixing bracket 282 can be made of a material having low thermal conductivity (e.g., a resin material). Alternatively, for example, a metal material is used for the fixing bracket 282, and a resin member or a ceramic member having low thermal conductivity may be interposed at a connection portion between the fixing bracket 282 and the link 201 to suppress heat conduction from the link 201 to the fixing bracket 282. Alternatively, for example, a metal material is used for the fixing bracket 282, but a resin member or a ceramic member having low thermal conductivity may be interposed between the fixing bracket 282 and the motor control device 242. In addition, a resin member or a ceramic member having low thermal conductivity may be interposed at a connection portion between the cover 232 and the link 201, or a resin member or a ceramic member having low thermal conductivity may be interposed at a connection portion between the cover 252 and the link 201.

In the present embodiment, since the cover 252 and the cover 232 covering side surfaces having the largest area in the external shape of the joint 222 are used as the heat dissipation members, high heat dissipation efficiency is achieved. The cover 252 and the cover 232 are disposed at positions facing each other with the link 201 or the link 202 interposed therebetween. The cover 252, which is an attachable/detachable outer cover disposed at a position intersecting the rotation axis A2 of the joint, is used as a first heat dissipation member, and the attachable/detachable cover 232 disposed in a direction intersecting the rotation axis A2 is used as a second heat dissipation member. The motor control device 242 and the first heat dissipation member are connected to each other by the first heat dissipation path (heat conduction member 272), and the electric motor 212 and the second heat dissipation member are connected to each other by the second heat dissipation path (heat conduction member 262).

As described above, since a structure for making it difficult to conduct heat between the heat dissipation paths is adopted by individually forming the heat dissipation path for the motor control device 242 and the heat dissipation path for the electric motor 212, heat discharged from the electric motor 212 is prevented from affecting the function of the motor control device 242. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### First Modification of Second Embodiment

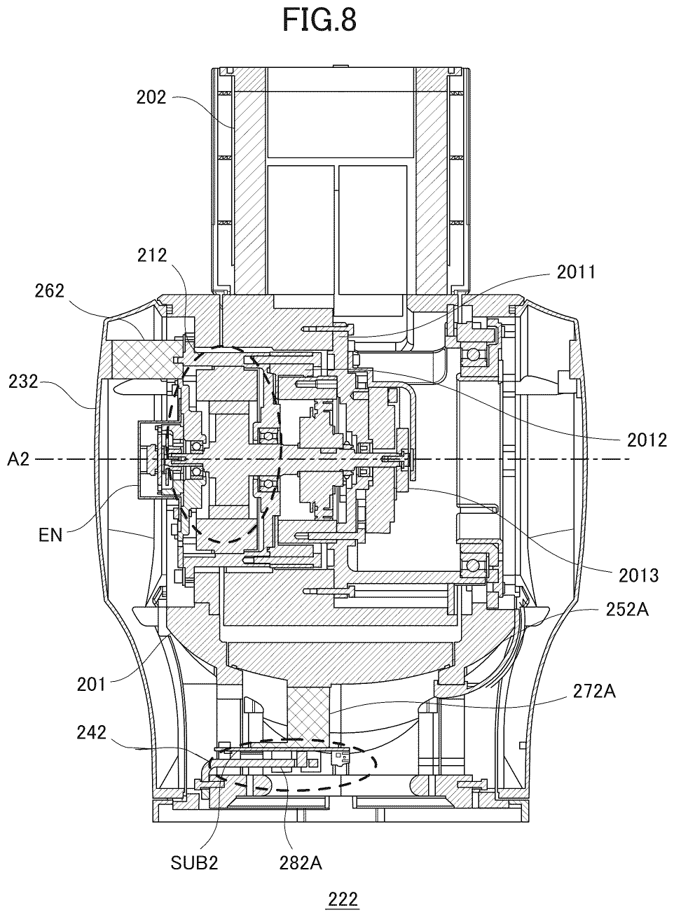

A first modification of the joint 222 according to the second embodiment will be described. FIG. 8 is a cross-sectional view for explaining an internal structure of the joint 222 according to the first modification. The description of elements and matters similar to those in the second embodiment will be simplified or omitted.

Similarly to the second embodiment illustrated in FIG. 7, in the first modification as well, a structure for making it difficult to conduct heat between the heat dissipation paths is adopted while the heat dissipation path for the motor control device 242 (motor control unit) and the heat dissipation path for the electric motor 212 are individually formed. However, the first modification is different from FIG. 7 in the position at which the motor control device 242 is installed and the configuration of the path for dissipating heat from motor control device 242.

In the first modification, the motor control device 242 is disposed on the left side of FIG. 8 so that the distance to the electric motor 212 is shorter than that in FIG. 7. By reducing the distance between the motor control device 242 and the electric motor 212, it is possible to shorten the length of the wiring laid to connect the motor control device 242 and the electric motor 212.

In the first modification as well, the heat generated by the electric motor 212 is dissipated to the cover 232 via the heat conduction member 262 serving as the second heat dissipation path, but the first heat dissipation path for dissipating heat from the motor control device 242 is different. As illustrated in FIG. 8, in order to connect the link 201 and the link 202 via the driving unit when assembling the robot arm 200, an opening is provided in the link 201, but the opening is covered with a cover 252A after the link 201 and the link 202 are connected.

In the first modification, the cover 252A, which does not intersect the rotation axis A2, is used as a heat dissipation member contacting outside air to dissipate heat from the motor control device 242. That is, the substrate SUB2 of the motor control device 242 is connected to the cover 252A via a heat conduction member 272A extending in a direction intersecting the rotation axis A2.

In the present modification as well, since the heat conduction member 272A for the first heat dissipation path and the heat conduction member 262 for the second heat dissipation path are separate members disposed apart from each other, heat generated by the electric motor 212 is not directly conducted from the second heat dissipation path to the first heat dissipation path.

Furthermore, it is preferable to employ a configuration in which heat conducted from the electric motor 212 to the cover 232 via the heat conduction member 262 is suppressed from being transmitted to the motor control device 242 via the link 201. Specifically, a fixing bracket 282A for fixing the motor control device 242 to the link 201 can be made of a material having low thermal conductivity (e.g., a resin material). Alternatively, for example, a metal material is used for the fixing bracket 282A, and a resin member or a ceramic member having low thermal conductivity may be interposed at a connection portion between the fixing bracket 282A and the link 201 to suppress heat conduction from the link 201 to the fixing bracket 282A. Alternatively, for example, a metal material is used for the fixing bracket 282A, but a resin member or a ceramic member having low thermal conductivity may be interposed between the fixing bracket 282A and the motor control device 242. In addition, a resin member or a ceramic member having low thermal conductivity may be interposed at a connection portion between the cover 232 and the link 201, or a resin member or a ceramic member having low thermal conductivity may be interposed at a connection portion between the cover 252A and the link 201.

As described above, since a structure for making it difficult to conduct heat between the heat dissipation paths is adopted while the heat dissipation path for the motor control device 242 and the heat dissipation path for the electric motor 212 are individually formed, heat discharged from the electric motor 212 is prevented from affecting the function of the motor control device 242. Therefore, in the present modification as well, even when the motor and the motor control device, which are heat generating elements, are installed relatively close to each other in the casing of the robot, heat can be appropriately dissipated from the motor and the motor control device, and the robot can be stably operated.

### Second Modification of Second Embodiment

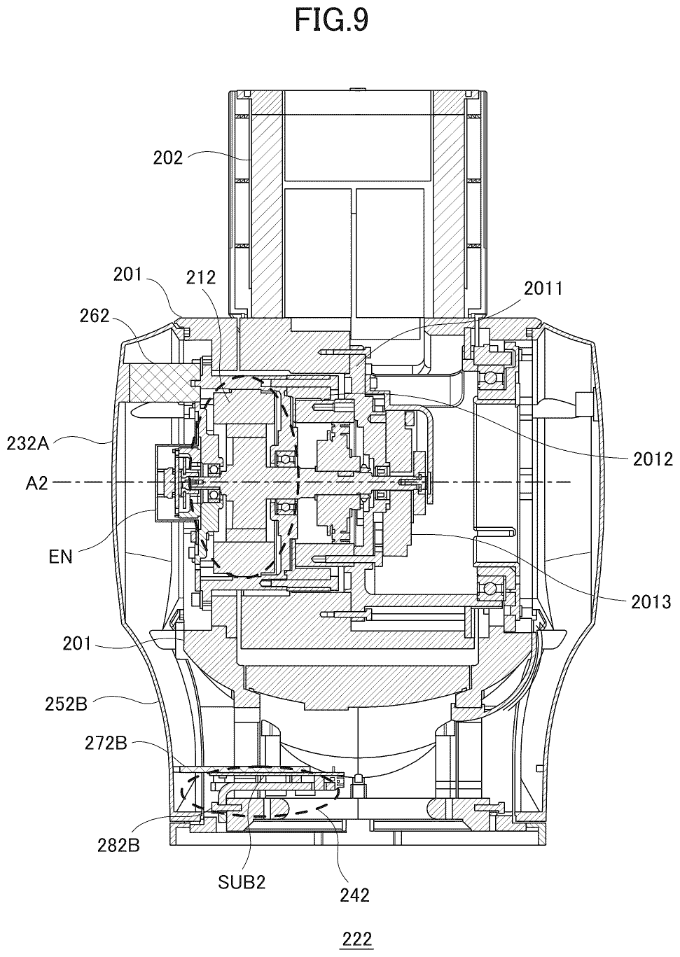

A second modification of the joint 222 according to the second embodiment will be described. FIG. 9 is a cross-sectional view for explaining an internal structure of the joint 222 according to the second modification. The description of elements and matters similar to those in the second embodiment will be simplified or omitted.

Similarly to the second embodiment illustrated in FIG. 7, in the second modification as well, a structure for making it difficult to conduct heat between the heat dissipation paths is adopted while the heat dissipation path for the motor control device 242 (motor control unit) and the heat dissipation path for the electric motor 212 are individually formed. However, the second modification is different from FIG. 7 in the position at which the motor control device 242 is installed and the configuration of the path for dissipating heat from motor control device 242.

In the second modification, the motor control device 242 is disposed on the left side of FIG. 9 so that the distance to the electric motor 212 is shorter than that in FIG. 7. By reducing the distance between the motor control device 242 and the electric motor 212, it is possible to shorten the length of the wiring laid to connect the motor control device 242 and the electric motor 212.

In the second modification, as illustrated in FIG. 9, the cover that covers the left side surface of the joint 222 is not a single body, but includes a cover 232A on the link 202 side and a cover 252B on the link 201 side, which are separated from each other. The gap between the cover 232A and the cover 252B may be filled with air, a heat insulating member (not illustrated) may be disposed in a partial portion of the gap, or the cover 232A and the cover 252B may be connected to each other by a heat insulating member (not illustrated). As the heat insulating member, a resin, a polymer material, or the like can be used. As described above, the cover 232A and the cover 252B have a structure in which heat is hardly conducted to each other.

In the second modification, heat generated by the electric motor 212 is dissipated to the cover 232A via the heat conduction member 262 serving as the second heat dissipation path, and heat generated by the motor control device 242 is dissipated to the cover 252B via the heat conduction member 272B as the first heat dissipation path.

In the second modification, one side surface of the joint 222 is covered with two covers separated from each other, that is, the cover 252B on the input link side and the cover 232A on the output link side, each being used as a heat dissipation member contacting outside air. The heat from the electric motor 212 is dissipated using the cover 232A intersecting the rotation axis A2, and the heat from the motor control device 242 is dissipated using the cover 252B not intersecting the rotation axis A2. The substrate SUB2 of the motor control device 242 is connected to the cover 252B via the heat conduction member 272B extending in a direction not intersecting the rotation axis A2.

In the present modification as well, since the heat conduction member 272B for the first heat dissipation path and the heat conduction member 262 for the second heat dissipation path are separate members disposed apart from each other, heat generated by the electric motor 212 is not directly conducted from the second heat dissipation path to the first heat dissipation path.

Furthermore, it is preferable to employ a configuration in which heat conducted from the electric motor 212 to the cover 232A via the heat conduction member 262 is suppressed from being transmitted to the motor control device 242 via the link 201. Specifically, a fixing bracket 282B for fixing the motor control device 242 to the link 201 can be made of a material having low thermal conductivity (e.g., a resin material). Alternatively, for example, a metal material is used for the fixing bracket 282B, and a resin member or a ceramic member having low thermal conductivity may be interposed at a connection portion between the fixing bracket 282B and the link 201 to suppress heat conduction from the link 201 to the fixing bracket 282B. Alternatively, for example, a metal material is used for the fixing bracket 282B, but a resin member or a ceramic member having low thermal conductivity may be interposed between the fixing bracket 282B and the motor control device 242. In addition, a resin member or a ceramic member having low thermal conductivity may be interposed at a connection portion between the cover 232A and the link 201, or a resin member or a ceramic member having low thermal conductivity may be interposed at a connection portion between the cover 252B and the link 201.

As described above, since a structure for making it difficult to conduct heat between the heat dissipation paths is adopted while the heat dissipation path for the motor control device 242 and the heat dissipation path for the electric motor 212 are individually formed, heat discharged from the electric motor 212 is prevented from affecting the function of the motor control device 242. Therefore, in the present modification as well, even when the motor and the motor control device, which are heat generating elements, are installed relatively close to each other in the casing of the robot, heat can be appropriately dissipated from the motor and the motor control device, and the robot can be stably operated.

### Third Embodiment

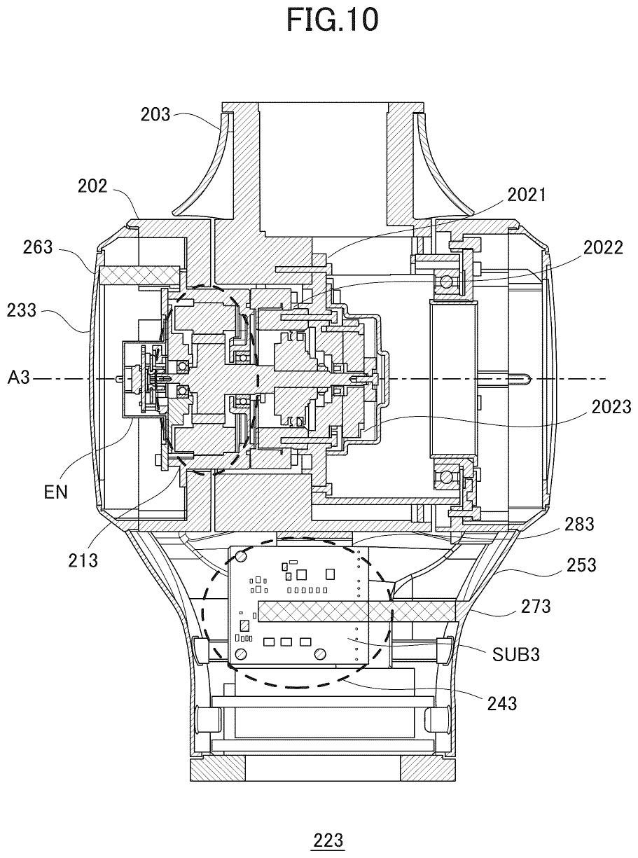

FIG. 10 is a cross-sectional view for explaining an internal structure of the joint 223 serving as a joint mechanism. The joint 223 is a joint third closest to the proximal end as illustrated in FIG. 2, and connects the link 202 and the link 203 of the robot arm 200.

The joint 223 support the link 202 and the link 203 at both ends by two bearings so that the link 203 is rotatable about the rotation axis A3. The link 203 is connected to an output side of a speed reducer 2022 via a connection member 2021, and the link 203 rotates about the rotation axis A3 with respect to the link 202 by rotating the electric motor 213. The electric motor 213 is provided with an encoder EN that detects its rotation.

The joint 223 includes an electric motor 213 (e.g., a servomotor), a speed reducer 2032, a brake 2023, and a motor control device 243, which are disposed in a space surrounded by a cover 253 and a cover 233. That is, in the internal space of the joint 223, the electric motor 213 and the motor control device 243, which are heat generating elements illustrated to be surrounded by dotted lines, are arranged relatively close to each other.

The motor control device 243 (motor control unit) is fixed to the link 202 via a fixing bracket 283, and includes a substrate SUB3 on which an electric circuit (control circuit) for controlling the drive of the electric motor 213 is mounted.

The electric motor 213 and the motor control device 243, which are heat generating elements, need to be provided with a heat dissipation unit. As will be described below, the present embodiment is characterized by the configurations of the heat dissipation paths for the electric motor 213 and the motor control device 243.

The electric motor 213, which works to rotate the robot arm closer to the distal end than the link 203, generates a large amount of heat when a large load is applied thereto, and a large amount of heat is discharged to the heat dissipation path for the electric motor 213.

On the other hand, when the temperature of the motor control device 243 rises excessively, the electric circuit (control circuit) malfunctions, and the electric motor 213 cannot be controlled to be normally driven. Therefore, the heat dissipation unit for the motor control device 243 is required to be able to stably discharge heat.

Generally, the heat dissipation paths are formed of members having good thermal conductivity. For example, when the member of the heat dissipation path for the motor control device 243 and the member of the heat dissipation path for the electric motor 213 are in contact with each other, or when the heat dissipation paths are formed by sharing the same member, heat conduction occurs between the heat dissipation paths.

If the heat dissipation path for the motor control device 243 and the heat dissipation path for the electric motor 213 are configured to easily conduct heat therebetween, the function of dissipating heat from the motor control device 243 may be affected by heat dissipation from the electric motor 213. When a large amount of heat is discharged from the electric motor 213 to the heat dissipation path and the temperature of the member constituting the heat dissipation path rises, the amount of heat discharged from the heat dissipation path for the motor control device 243 decreases, or in a certain case, some of the heat generated by the electric motor 213 is conducted to the motor control device 243. Then, the function of dissipating heat from the motor control device 243 decreases, and the temperature of the motor control device 243 rises, which increases the possibility that the electric circuit (control circuit) malfunctions.

In the present embodiment, a structure for making it difficult to conduct heat between the heat dissipation paths is adopted while the heat dissipation path for the motor control device 243 and the heat dissipation path for the electric motor 213 are individually formed by using members having good thermal conductivity.

That is, the substrate SUB3 on which the electric circuit (control circuit) in the motor control device 243 is mounted is connected to the cover 253 (first heat dissipation member) via a heat conduction member 273 (first heat conduction member) serving as a first heat dissipation path. Heat generated by the electric circuit (control circuit) on the substrate SUB3 is dissipated from the cover 253 to the atmosphere. In order to bring the substrate SUB3 and the heat conduction member 273 into contact with each other over a wide area without short-circuiting the electric circuit (control circuit) in the substrate SUB3, the substrate SUB3 and the heat conduction member 273 may be disposed with a heat conduction sheet interposed therebetween, the heat conduction sheet being electrically insulating but providing good thermal conductivity.

In addition, the electric motor 213 is connected to the cover 233 (second heat dissipation member) via a heat conduction member 263 (second heat conduction member) serving as a second heat dissipation path. The heat generated by the electric motor 213 is dissipated from the cover 233 to the atmosphere. For example, a housing (exterior member) on the stator side of the electric motor 213 and the heat conduction member 263 may be connected to each other over a wide area.

For the link 202, the housing of the electric motor 213, the heat conduction member 263, the heat conduction member 273, the fixing bracket 283, the cover 233, and the cover 253, for example, members made of an aluminum alloy, which is lightweight, can be used, but the members are not limited thereto. Members made of another metal, e.g., a magnesium alloy or an iron alloy, may be used. The heat conduction member 263 and the heat conduction member 273 may be made of a metal having high thermal conductivity, such as copper, or a polymer material.

As described above, in the present embodiment, since the heat conduction member 273 for the first heat dissipation path and the heat conduction member 263 for the second heat dissipation path are separate members disposed apart from each other, heat generated by the electric motor 213 is not directly conducted from the second heat dissipation path to the first heat dissipation path.

Furthermore, it is preferable to employ a configuration in which heat conducted from the electric motor 213 to the cover 233 via the heat conduction member 263 is suppressed from being transmitted to the motor control device 243 via the link 202. Specifically, the fixing bracket 283 can be made of a material having low thermal conductivity (e.g., a resin material). Alternatively, for example, a metal material is used for the fixing bracket 283, and a resin member or a ceramic member having low thermal conductivity may be interposed at a connection portion between the fixing bracket 283 and the link 202 to suppress heat conduction from the link 202 to the fixing bracket 283. Alternatively, for example, a metal material is used for the fixing bracket 283, but a resin member or a ceramic member having low thermal conductivity may be interposed between the fixing bracket 283 and the motor control device 243. In addition, a resin member or a ceramic member having low thermal conductivity may be interposed at a connection portion between the cover 233 and the link 202, or a resin member or a ceramic member having low thermal conductivity may be interposed at a connection portion between the cover 253 and the link 202.

In the present embodiment, since the cover 253 and the cover 233 covering side surfaces having the largest area in the external shape of the joint 223 are used as the heat dissipation members, high heat dissipation efficiency is achieved. The cover 253 and the cover 233 are disposed at positions facing each other with the link 202 or the link 203 interposed therebetween. The cover 253, which is an attachable/detachable outer cover disposed at a position intersecting the rotation axis A3 of the joint, is used as a first heat dissipation member, and the attachable/detachable cover 233 disposed in a direction intersecting the rotation axis A3 is used as a second heat dissipation member. The motor control device 243 and the first heat dissipation member are connected to each other by the first heat dissipation path (heat conduction member 273), and the electric motor 213 and the second heat dissipation member are connected to each other by the second heat dissipation path (heat conduction member 263). In the second embodiment of FIG. 7, the main surface of the substrate SUB2 of the motor control device 242 is installed in parallel with the casing 200a of the proximal portion, that is, horizontally, but in the present embodiment, the main surface of the substrate SUB3 is installed in a direction intersecting the main surface of the cover 253.

As described above, since a structure for making it difficult to conduct heat between the heat dissipation paths is adopted while the heat dissipation path for the motor control device 243 and the heat dissipation path for the electric motor 213 are individually formed, heat discharged from the electric motor 213 is prevented from affecting the function of the motor control device 243. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### Fourth Embodiment

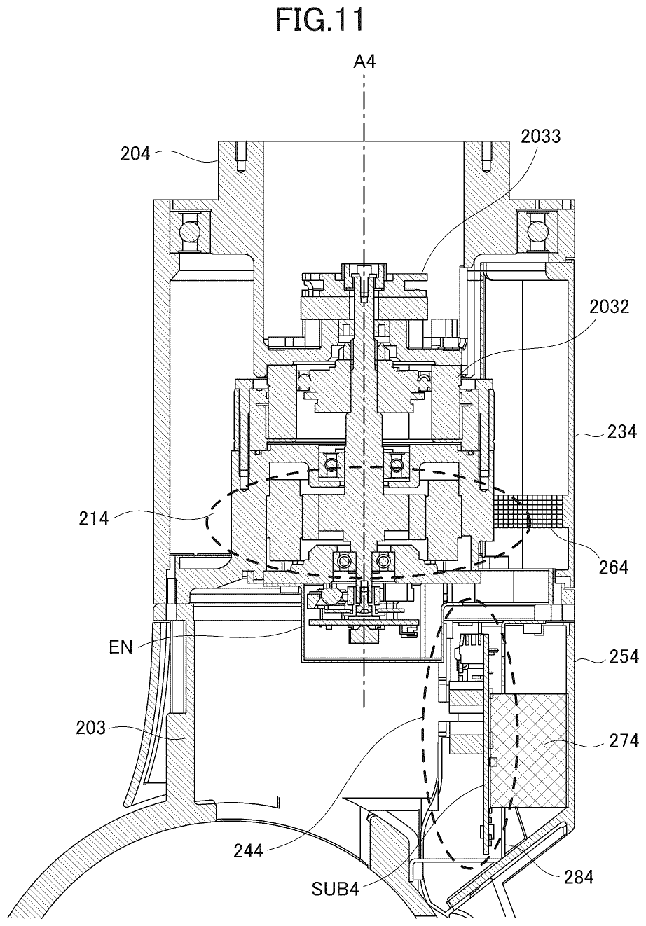

FIG. 11 is a cross-sectional view for explaining an internal structure of the joint 224 serving as a joint mechanism. The joint 224 is a joint fourth closest to the proximal end as illustrated in FIG. 2, and connects the link 203 and the link 204 of the robot arm 200.

The joint 224 support the link 203 and the link 204 at both ends by two bearings so that the link 204 is rotatable about the rotation axis A4. Note that the rotation axis A3 in FIG. 10 and the rotation axis A4 in FIG. 11 are arranged to be orthogonal to each other.

The joint 224 includes an electric motor 214 (e.g., a servomotor), a speed reducer 2032, a brake 2033, and a motor control device 244, which are disposed in a space surrounded by a cover 254 and a cover 234. That is, in the internal space of the joint 224, the electric motor 214 and the motor control device 244, which are heat generating elements illustrated to be surrounded by dotted lines, are arranged relatively close to each other. The electric motor 214 is provided with an encoder EN that detects its rotation.

The motor control device 244 is fixed to the link 203 via a fixing bracket 284, and includes a substrate SUB4 on which an electric circuit (control circuit) for controlling the drive of the electric motor 214 is mounted.

An opening is provided on one side surface of the link 203 to enable internal components such as the electric motor 214 and the motor control device 244 to be attachable/detachable. An opening portion for attaching and detaching the electric motor 214, the speed reducer 2032, and the brake 2033 is covered with the cover 234 that is attachable/detachable, and an opening portion for attaching and detaching the motor control device 244 is covered with the cover 254 that is attachable/detachable. The cover 234 and the cover 254 are separated from each other. That is, the cover 234 and the cover 254 have a structure in which heat is hardly conducted to each other.

The electric motor 214 and the motor control device 244, which are heat generating elements, need to be provided with a heat dissipation unit. As will be described below, the present embodiment is characterized by the configurations of the heat dissipation paths for the electric motor 214 and the motor control device 244.

The electric motor 214, which works to rotate the robot arm closer to the distal end than the link 204, generates a large amount of heat when a large load is applied thereto, and a large amount of heat is discharged to the heat dissipation path for the electric motor 214.

On the other hand, when the temperature of the motor control device 244 (motor control unit) rises excessively, the electric circuit (control circuit) malfunctions and the electric motor 214 cannot be controlled to be normally driven. Therefore, the heat dissipation unit for the motor control device 244 is required to be able to stably discharge heat.

Generally, the heat dissipation paths are formed of members having good thermal conductivity. For example, when the member of the heat dissipation path for the motor control device 244 and the member of the heat dissipation path for the electric motor 214 are in contact with each other, or when the heat dissipation paths are formed by sharing the same member, heat conduction occurs between the heat dissipation paths.

If the heat dissipation path for the motor control device 244 and the heat dissipation path for the electric motor 214 are configured to easily conduct heat therebetween, the function of dissipating heat from the motor control device 244 may be affected by heat dissipation from the electric motor 214. When a large amount of heat is discharged from the electric motor 211 to the heat dissipation path and the temperature of the member constituting the heat dissipation path rises, the amount of heat discharged from the heat dissipation path for the motor control device 244 decreases, or in a certain case, some of the heat generated by the electric motor 214 is conducted to the motor control device 244. Then, the function of dissipating heat from the motor control device 244 decreases, and the temperature of the motor control device 244 rises, which increases the possibility that the electric circuit (control circuit) malfunctions.

In the present embodiment, a structure for making it difficult to conduct heat between the heat dissipation paths is adopted while the heat dissipation path for the motor control device 244 and the heat dissipation path for the electric motor 214 are individually formed by using members having good thermal conductivity.

That is, the substrate SUB4 on which the electric circuit (control circuit) in the motor control device 244 is mounted is connected to the cover 254 (first heat dissipation member) via a heat conduction member 274 (first heat conduction member) serving as a first heat dissipation path. Heat generated by the electric circuit (control circuit) on the substrate SUB4 is dissipated from the cover 254 to the atmosphere. In order to bring the substrate SUB4 and the heat conduction member 274 into contact with each other over a wide area without short-circuiting the electric circuit (control circuit) in the substrate SUB4, the substrate SUB4 and the heat conduction member 274 may be disposed with a heat conduction sheet interposed therebetween, the heat conduction sheet being electrically insulating but providing good thermal conductivity.

In addition, the electric motor 214 is connected to the cover 234 (second heat dissipation member) via a heat conduction member 264 (second heat conduction member) serving as a second heat dissipation path. The heat generated by the electric motor 214 is dissipated from the cover 234 to the atmosphere. For example, a housing (exterior member) on the stator side of the electric motor 214 and the heat conduction member 264 may be connected to each other over a wide area.

For the link 203, the housing of the electric motor 214, the heat conduction member 264, the heat conduction member 274, the fixing bracket 284, the cover 234, and the cover 254, for example, members made of an aluminum alloy, which is lightweight, can be used, but the members are not limited thereto. Members made of another metal, e.g., a magnesium alloy or an iron alloy, may be used. The heat conduction member 264 and the heat conduction member 274 may be made of a metal having high thermal conductivity, such as copper, or a polymer material.

As described above, in the present embodiment, since the heat conduction member 274 for the first heat dissipation path and the heat conduction member 264 for the second heat dissipation path are separate members disposed apart from each other, heat generated by the electric motor 214 is not directly conducted from the second heat dissipation path to the first heat dissipation path.

Furthermore, it is preferable to employ a configuration in which heat conducted from the electric motor 214 to the cover 234 via the heat conduction member 264 is suppressed from being transmitted to the motor control device 244 via the link 203. Specifically, the fixing bracket 284 can be made of a material having low thermal conductivity (e.g., a resin material). Alternatively, for example, a metal material is used for the fixing bracket 284, and a resin member or a ceramic member having low thermal conductivity may be interposed at a connection portion between the fixing bracket 284 and the link 203 to suppress heat conduction from the link 203 to the fixing bracket 284. Alternatively, for example, a metal material is used for the fixing bracket 284, but a resin member or a ceramic member having low thermal conductivity may be interposed between the fixing bracket 284 and the motor control device 244. In addition, a resin member or a ceramic member having low thermal conductivity may be interposed at a connection portion between the cover 234 and the link 203, or a resin member or a ceramic member having low thermal conductivity may be interposed at a connection portion between the cover 254 and the link 203.

In the present embodiment, the cover 254, which is an attachable/detachable outer cover disposed at a position not intersecting the rotation axis A4 of the joint, is used as a first heat dissipation member, and the attachable/detachable cover 234 disposed in a direction not intersecting the rotation axis A4 is used as a second heat dissipation member. The motor control device 244 and the first heat dissipation member are connected to each other by the first heat dissipation path (heat conduction member 274), and the electric motor 214 and the second heat dissipation member are connected to each other by the second heat dissipation path (heat conduction member 264).

As described above, since a structure for making it difficult to conduct heat between the heat dissipation paths is adopted while the heat dissipation path for the motor control device 244 and the heat dissipation path for the electric motor 214 are individually formed, heat discharged from the electric motor 214 is prevented from affecting the function of the motor control device 244. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### Fifth Embodiment

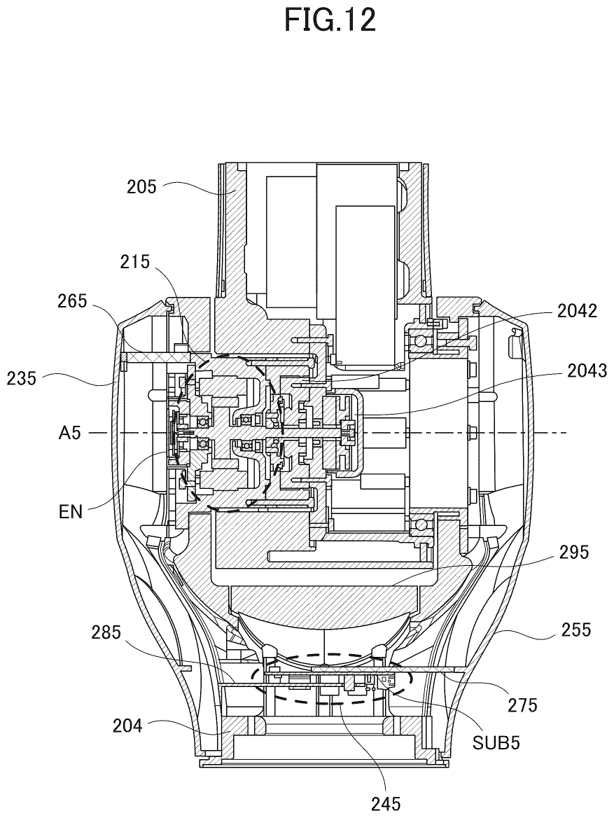

FIG. 12 is a cross-sectional view for explaining an internal structure of the joint 225 serving as a joint mechanism. The joint 225 is a joint fifth closest to the proximal end as illustrated in FIG. 2, and connects the link 204 and the link 205 of the robot arm 200.

The joint 225 support the link 204 and the link 205 at both ends by two bearings so that the link 205 is rotatable about the rotation axis A5. The link 205 is connected to an output side of a speed reducer 2042, and the link 205 rotates about the rotation axis A5 with respect to the link 204 by rotating the electric motor 215. The electric motor 215 is provided with an encoder EN that detects its rotation. Note that the rotation axis A4 in FIG. 11 and the rotation axis A5 in FIG. 12 are arranged to be orthogonal to each other. In order to connect the link 204 and the link 205 via the driving unit when assembling the robot arm 200, an opening is provided in the link 204, but the opening is covered with a cover 295 after the link 204 and the link 205 are connected.

The joint 225 includes an electric motor 215 (e.g., a servomotor), a speed reducer 2042, a brake 2043, and a motor control device 245, which are disposed in a space surrounded by a cover 255 and a cover 235. That is, in the internal space of the joint 225, the electric motor 215 and the motor control device 245, which are heat generating elements illustrated to be surrounded by dotted lines, are arranged relatively close to each other.

The motor control device 245 (motor control unit) is fixed to the link 204 via a fixing bracket 285, and includes a substrate SUB5 on which an electric circuit (control circuit) for controlling the drive of the electric motor 215 is mounted.

The electric motor 215 and the motor control device 245, which are heat generating elements, need to be provided with a heat dissipation unit. As will be described below, the present embodiment is characterized by the configurations of the heat dissipation paths for the electric motor 215 and the motor control device 245.

The electric motor 215, which works to rotate the robot arm closer to the distal end than the link 205, generates a large amount of heat when a large load is applied thereto, and a large amount of heat is discharged to the heat dissipation path for the electric motor 215.

On the other hand, when the temperature of the motor control device 245 rises excessively, the electric circuit (control circuit) malfunctions, and the electric motor 215 cannot be controlled to be normally driven. Therefore, the heat dissipation unit for the motor control device 245 is required to be able to stably discharge heat.

Generally, the heat dissipation paths are formed of members having good thermal conductivity. For example, when the member of the heat dissipation path for the motor control device 245 and the member of the heat dissipation path for the electric motor 215 are in contact with each other, or when the heat dissipation paths are formed by sharing the same member, heat conduction occurs between the heat dissipation paths.

If the heat dissipation path for the motor control device 245 and the heat dissipation path for the electric motor 215 are configured to easily conduct heat therebetween, the function of dissipating heat from the motor control device 245 may be affected by heat dissipation from the electric motor 215. When a large amount of heat is discharged from the electric motor 215 to the heat dissipation path and the temperature of the member constituting the heat dissipation path rises, the amount of heat discharged from the heat dissipation path for the motor control device 245 decreases, or in a certain case, some of the heat generated by the electric motor 215 is conducted to the motor control device 245. Then, the function of dissipating heat from the motor control device 245 decreases, and the temperature of the motor control device 245 rises, which increases the possibility that the electric circuit (control circuit) malfunctions.

In the present embodiment, a structure for making it difficult to conduct heat between the heat dissipation paths is adopted while the heat dissipation path for the motor control device 245 and the heat dissipation path for the electric motor 215 are individually formed by using members having good thermal conductivity.

That is, the substrate SUB5 on which the electric circuit (control circuit) in the motor control device 245 is mounted is connected to the cover 255 (first heat dissipation member) via a heat conduction member 275 (first heat conduction member) serving as a first heat dissipation path. Heat generated by the electric circuit (control circuit) on the substrate SUB5 is dissipated from the cover 255 to the atmosphere. In order to bring the substrate SUB5 and the heat conduction member 275 into contact with each other over a wide area without short-circuiting the electric circuit (control circuit) in the substrate SUB5, the substrate SUB5 and the heat conduction member 275 may be disposed with a heat conduction sheet interposed therebetween, the heat conduction sheet being electrically insulating but providing good thermal conductivity.

In addition, the electric motor 215 is connected to the cover 235 (second heat dissipation member) via a heat conduction member 265 (second heat conduction member) serving as a second heat dissipation path. The heat generated by the electric motor 215 is dissipated from the cover 235 to the atmosphere. For example, a housing (exterior member) on the stator side of the electric motor 215 and the heat conduction member 265 may be connected to each other over a wide area.

For the link 204, the housing of the electric motor 215, the heat conduction member 265, the heat conduction member 275, the fixing bracket 285, the cover 235, and the cover 255, for example, members made of an aluminum alloy, which is lightweight, can be used, but the members are not limited thereto. Members made of another metal, e.g., a magnesium alloy or an iron alloy, may be used. The heat conduction member 265 and the heat conduction member 275 may be made of a metal having high thermal conductivity, such as copper, or a polymer material.

As described above, in the present embodiment, since the heat conduction member 275 for the first heat dissipation path and the heat conduction member 265 for the second heat dissipation path are separate members disposed apart from each other, heat generated by the electric motor 215 is not directly conducted from the second heat dissipation path to the first heat dissipation path.

Furthermore, it is preferable to employ a configuration in which heat conducted from the electric motor 215 to the cover 235 via the heat conduction member 265 is suppressed from being transmitted to the motor control device 245 via the link 204. Specifically, the fixing bracket 285 can be made of a material having low thermal conductivity (e.g., a resin material). Alternatively, for example, a metal material is used for the fixing bracket 285, and a resin member or a ceramic member having low thermal conductivity may be interposed at a connection portion between the fixing bracket 285 and the link 204 to suppress heat conduction from the link 204 to the fixing bracket 285. Alternatively, for example, a metal material is used for the fixing bracket 285, but a resin member or a ceramic member having low thermal conductivity may be interposed between the fixing bracket 285 and the motor control device 245. In addition, a resin member or a ceramic member having low thermal conductivity may be interposed at a connection portion between the cover 235 and the link 204, or a resin member or a ceramic member having low thermal conductivity may be interposed at a connection portion between the cover 255 and the link 204.

In the present embodiment, since the cover 255 and the cover 235 covering side surfaces having the largest area in the external shape of the joint 225 are used as the heat dissipation members, high heat dissipation efficiency is achieved. The cover 255 and the cover 235 are disposed at positions facing each other with the link 204 or the link 205 interposed therebetween. The cover 255, which is an attachable/detachable outer cover disposed at a position intersecting the rotation axis A5 of the joint, is used as a first heat dissipation member, and the attachable/detachable cover 235 disposed in a direction intersecting the rotation axis A5 is used as a second heat dissipation member. The motor control device 245 and the first heat dissipation member are connected to each other by the first heat dissipation path (heat conduction member 275), and the electric motor 215 and the second heat dissipation member are connected to each other by the second heat dissipation path (heat conduction member 265).

As described above, since a structure for making it difficult to conduct heat between the heat dissipation paths is adopted while the heat dissipation path for the motor control device 245 and the heat dissipation path for the electric motor 215 are individually formed, heat discharged from the electric motor 215 is prevented from affecting the function of the motor control device 245. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### Sixth Embodiment

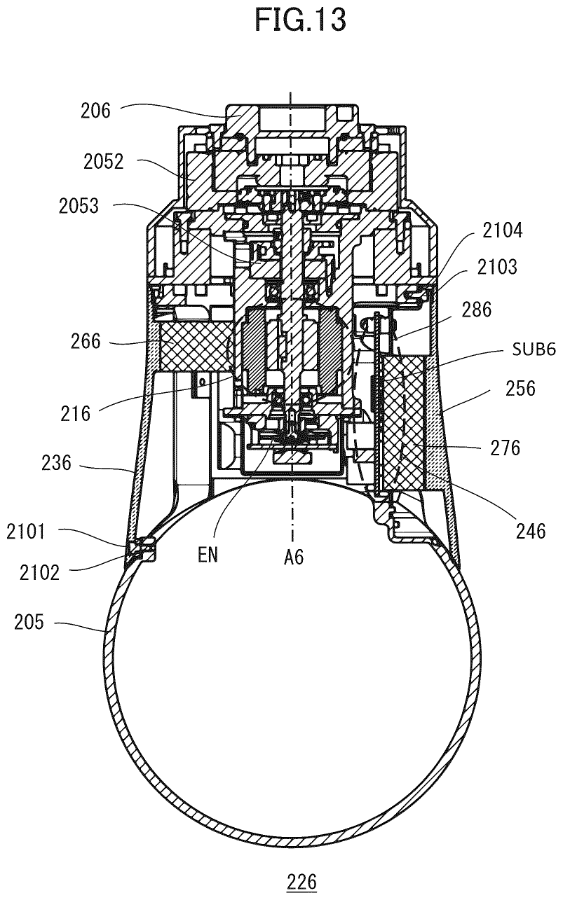

FIG. 13 is a cross-sectional view for explaining an internal structure of the joint 226 serving as a joint mechanism. The joint 226 is a joint sixth closest to the proximal end as illustrated in FIG. 2, and connects the link 205 and the link 206 of the robot arm 200.

The joint 226 supports a portion between the link 205 and the link 206 at both ends by two bearings so that the link 206 is rotatable about the rotation axis A6. Note that the rotation axis A5 in FIG. 12 and the rotation axis A6 in FIG. 13 are arranged to be orthogonal to each other.

The joint 226 includes an electric motor 216 (e.g., a servomotor), a speed reducer 2052, a brake 2053, and a motor control device 246, which are disposed in a space surrounded by a cover 256 and a cover 236. That is, in the internal space of the joint 226, the electric motor 216 and the motor control device 246, which are heat generating elements illustrated to be surrounded by dotted lines, are arranged relatively close to each other. The electric motor 216 is provided with an encoder EN that detects its rotation.

The motor control device 246 (motor control unit) is fixed to the link 205 via a fixing bracket 286, and includes a substrate SUB6 on which an electric circuit (control circuit) for controlling the drive of the electric motor 216 is mounted.

The side surface of the joint 226 is covered with a cover 236 and a cover 256 that are attachable/detachable, and the cover 236 and the cover 256 are separated from each other. That is, the cover 236 and the cover 256 have a structure in which heat is hardly conducted to each other.

The electric motor 216 and the motor control device 246, which are heat generating elements, need to be provided with a heat dissipation unit. As will be described below, the present embodiment is characterized by the configurations of the heat dissipation paths for the electric motor 216 and the motor control device 246.

The electric motor 216, which works to rotate the robot arm closer to the distal end than the link 206, generates a large amount of heat when a large load is applied thereto, and a large amount of heat is discharged to the heat dissipation path for the electric motor 216.

On the other hand, when the temperature of the motor control device 246 rises excessively, the electric circuit (control circuit) malfunctions, and the electric motor 216 cannot be controlled to be normally driven. Therefore, the heat dissipation unit for the motor control device 246 is required to be able to stably discharge heat.

Generally, the heat dissipation paths are formed of members having good thermal conductivity. For example, when the member of the heat dissipation path for the motor control device 246 and the member of the heat dissipation path for the electric motor 216 are in contact with each other, or when the heat dissipation paths are formed by sharing the same member, heat conduction occurs between the heat dissipation paths.

If the heat dissipation path for the motor control device 246 and the heat dissipation path for the electric motor 216 are configured to easily conduct heat therebetween, the function of dissipating heat from the motor control device 246 may be affected by heat dissipation from the electric motor 216. When a large amount of heat is discharged from the electric motor 216 to the heat dissipation path and the temperature of the member constituting the heat dissipation path rises, the amount of heat discharged from the heat dissipation path for the motor control device 246 decreases, or in a certain case, some of the heat generated by the electric motor 216 is conducted to the motor control device 246. Then, the function of dissipating heat from the motor control device 246 decreases, and the temperature of the motor control device 246 rises, which increases the possibility that the electric circuit (control circuit) malfunctions.

In the present embodiment, a structure for making it difficult to conduct heat between the heat dissipation paths is adopted while the heat dissipation path for the motor control device 246 and the heat dissipation path for the electric motor 216 are individually formed by using members having good thermal conductivity.

That is, the substrate SUB6 on which the electric circuit (control circuit) in the motor control device 246 is mounted is connected to the cover 256 (first heat dissipation member) via a heat conduction member 276 (first heat conduction member) serving as a first heat dissipation path. Heat generated by the electric circuit (control circuit) on the substrate SUB6 is dissipated from the cover 256 to the atmosphere. In order to bring the substrate SUB6 and the heat conduction member 276 into contact with each other over a wide area without short-circuiting the electric circuit (control circuit) in the substrate SUB6, the substrate SUB6 and the heat conduction member 276 may be disposed with a heat conduction sheet interposed therebetween, the heat conduction sheet being electrically insulating but providing good thermal conductivity.

In addition, the electric motor 216 is connected to the cover 236 (second heat dissipation member) via a heat conduction member 266 (second heat conduction member) serving as a second heat dissipation path. The heat generated by the electric motor 216 is dissipated from the cover 236 to the atmosphere. For example, a housing (exterior member) on the stator side of the electric motor 216 and the heat conduction member 266 may be connected to each other over a wide area.

For the link 205, the housing of the electric motor 216, the heat conduction member 266, the heat conduction member 276, the fixing bracket 286, the cover 236, and the cover 256, for example, members made of an aluminum alloy, which is lightweight, can be used, but the members are not limited thereto. Members made of another metal, e.g., a magnesium alloy or an iron alloy, may be used. The heat conduction member 266 and the heat conduction member 276 may be made of a metal having high thermal conductivity, such as copper, or a polymer material.

As described above, in the present embodiment, since the heat conduction member 276 for the first heat dissipation path and the heat conduction member 266 for the second heat dissipation path are separate members disposed apart from each other, heat generated by the electric motor 216 is not directly conducted from the second heat dissipation path to the first heat dissipation path.

Furthermore, it is preferable to employ a configuration in which heat conducted from the electric motor 216 to the cover 236 via the heat conduction member 266 is suppressed from being transmitted to the motor control device 246 via the link 205. Specifically, the fixing bracket 286 can be made of a material having low thermal conductivity (e.g., a resin material). Alternatively, for example, a metal material is used for the fixing bracket 286, and a resin member or a ceramic member having low thermal conductivity may be interposed at a connection portion between the fixing bracket 286 and the link 205 to suppress heat conduction from the link 205 to the fixing bracket 286. Alternatively, for example, a metal material is used for the fixing bracket 286, but a resin member or a ceramic member having low thermal conductivity may be interposed between the fixing bracket 286 and the motor control device 246.

Furthermore, in the present embodiment, when the cover 236 is fixed to the link 205, a bolt 2101 and a threaded portion of the link 205 are screw-connected to each other, with a heat insulating member 2102 sandwiched between the contact surfaces of the link 205 and the cover 236. In addition, when the fixing bracket 286 is fixed to the link 205, a bolt 2103 and a threaded portion of the link 205 are screw-connected to each other, with a heat insulating member 2104 sandwiched between the contact surfaces of the link 205 and the fixing bracket 286. The heat insulating member 2102 and the heat insulating member 2104 may be formed of, for example, a polymer material (a resin or the like) or ceramic having low thermal conductivity.

In the present embodiment, the cover 256, which is an attachable/detachable outer cover disposed at a position not intersecting the rotation axis A6 of the joint, is used as a first heat dissipation member, and the attachable/detachable cover 236 disposed at a position not intersecting the rotation axis A6 is used as a second heat dissipation member. The motor control device 246 and the first heat dissipation member are connected to each other by the first heat dissipation path (heat conduction member 276), and the electric motor 216 and the second heat dissipation member are connected to each other by the second heat dissipation path (heat conduction member 266).

As described above, since a structure for making it difficult to conduct heat between the heat dissipation paths is adopted while the heat dissipation path for the motor control device 246 and the heat dissipation path for the electric motor 216 are individually formed, heat discharged from the electric motor 216 is prevented from affecting the function of the motor control device 246. Therefore, according to the present embodiment, even when the motor and the motor control device, which are heat generating elements, are installed relatively close to each other in the casing of the robot, heat can be appropriately dissipated from the motor and the motor control device, and the robot can be stably operated.

### Modification

Note that the present invention is not limited to the above-described embodiments, and many modifications can be made within the technical spirit of the present invention. For example, all or some of the different embodiments described above may be combined for implementation.

The robot according to the embodiment is not limited to the form including the six-axis vertical multi-joint arm illustrated in FIG. 2, and may be of various types such as a vertical multi-joint type with a different number of axes, a parallel link type, and a linear motion joint type.

The robot does not need to include all the joint mechanisms illustrated in the first to sixth embodiments. At least one of the joint mechanisms included in the robot may have a heat dissipation path for the motor control device and a heat dissipation path for the electric motor that are provided independently as exemplified in the embodiment.

The first heat dissipation member and/or the second heat dissipation member may be any member that is in contact with the atmosphere over a wide area to exhibit a heat dissipation effect. That is, the first heat dissipation member and/or the second heat dissipation member do not need to be a cover member mounted on the joint mechanism in an attachable/detachable manner, and may be, for example, a mechanism member fixedly installed on the outer surface of the joint mechanism. At least one of the first heat dissipation member and the second heat dissipation member may have an uneven shape or a fin shape on the outer surface in order to enhance the heat dissipation effect, or may have an opening for allowing air to flow between the outside air side and the heat conduction member side.

Although the first heat dissipation member and the second heat dissipation member are separated from each other, a low heat-conductive member (e.g., a resin member or a ceramic member) having low thermal conductivity may be disposed between the two separated members.

In the joint mechanism according to the embodiment, an increase in temperature of the motor control unit caused by heat discharged from the electric motor is suppressed, whereby the stability and accuracy of the operation of the joint mechanism are secured. Therefore, a position sensor that acquires information regarding a position of the link on the terminal end side with respect to the link on the proximal end side is provided in the joint mechanism, and a control unit controls the motor control unit using the information acquired by the position sensor, thereby making it possible to accurately control the position of the robot. Alternatively, a torque sensor that detects information regarding a torque for rotating the link on the terminal end side with respect to the link on the proximal end side is provided, and a control unit controls the motor control unit using the information acquired by the torque sensor, thereby making it possible to accurately control the torque of the robot.

The operations to be executed by the robot device including the joint mechanism according to the embodiment are typically operations related to the manufacture of an article, representative examples of which include component assembly work, component conveyance work, component processing work (cutting, polishing, drilling, painting, bonding, welding, and the like), component cleaning work, and the like. However, other operations may be performed by the robot device.

The joint mechanism according to the embodiment can be applied to various machines and facilities such as an industrial robot, a service robot, and a processing machine operated by a numerical control of a computer. For example, the joint mechanism according to the embodiment can be applied to a joint of a machine and a facility capable of automatically performing an operation for expansion and contraction, bending and stretching, vertical movement, horizontal movement, turning, or a combination thereof based on information in the storage device provided in the control device. A control method and a control program for operating the robot including the joint mechanism according to the embodiment, and a computer-readable recording medium storing the control program are also included in the embodiments of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-159240, filed Sep. 22, 2023, which is hereby incorporated by reference herein in its entirety.

What is claimed is:

1. A robot comprising:
a first link;
a second link;
a motor configured to displace the second link with respect to the first link;
a motor control unit configured to control the motor;
a first heat dissipation member;
a second heat dissipation member,
a first heat conduction member configured to connect the motor control unit and the first heat dissipation member to each other; and
a second heat conduction member configured to connect the motor and the second heat dissipation member to each other,
wherein the first heat conduction member and the second heat conduction member are separated from each other, and the first heat dissipation member and the second heat dissipation member are separated from each other.

2. The robot according to claim 1,
wherein the motor control unit is fixed to the first link via a fixing bracket that is a member having low thermal conductivity.

3. The robot according to claim 1,
wherein the motor control unit is fixed to the first link via a fixing bracket, and a member having low thermal conductivity is interposed between the motor control unit and the fixing bracket.

4. The robot according to claim 1,
wherein the motor control unit is fixed to the first link via a fixing bracket, and a member having low thermal conductivity is interposed between the fixing bracket and the first link.

5. The robot according to claim 1,
wherein a member having low thermal conductivity is disposed between the first heat dissipation member and the second heat dissipation member.

6. The robot according to claim 1,
wherein the first heat dissipation member is fixed to the first link via a member having low thermal conductivity.

7. The robot according to claim 1,
wherein the second heat dissipation member is fixed to the first link via a member having low thermal conductivity.

8. The robot according to claim 2,
wherein the member having low thermal conductivity is a resin member or a ceramic member.

9. The robot according to claim 1,
wherein the motor control unit includes a substrate on which a control circuit is mounted, and
the substrate and the first heat conduction member are in surface contact with each other with an electrically insulating heat conduction sheet interposed therebetween.

10. The robot according to claim 1,
wherein at least one of the first heat dissipation member and the second heat dissipation member has an uneven shape or a fin shape on an outer surface thereof.

11. The robot according to claim 1,
wherein at least one of the first heat dissipation member and the second heat dissipation member includes an opening for allowing air to flow therethrough.

12. The robot according to claim 1, further comprising
an air cooling fan for blowing air to at least one of the first heat dissipation member and the second heat dissipation member.

13. The robot according to claim 1,
wherein the first heat dissipation member is disposed at a position not intersecting a rotation axis of the second link, and
the second heat dissipation member is disposed at a position intersecting the rotation axis of the second link.

14. The robot according to claim 1,
wherein the first heat dissipation member and the second heat dissipation member are disposed at positions intersecting a rotation axis of the second link.

15. The robot according to claim 1,
wherein the first heat dissipation member and the second heat dissipation member are cover members of a joint mechanism configured to connect the first link and the second link to each other.

16. The robot according to claim 15,
wherein the first heat dissipation member is a cover member configured to cover one side surface of the joint mechanism, and
the second heat dissipation member is a cover member configured to cover another side surface of the joint mechanism.

17. The robot according to claim 15,
wherein the first heat dissipation member is a cover member configured to cover a part of a side surface of the joint mechanism, and
the second heat dissipation member is a cover member configured to cover another part of the side surface.

18. The robot according to claim 1, further comprising
a position sensor configured to acquire information regarding a position of the second link with respect to the first link.

19. The robot according to claim 1, further comprising
a torque sensor configured to detect information regarding a torque for rotating the second link with respect to the first link.

20. A control method of a robot, the method comprising: controlling a motor by a motor control unit,
wherein the robot includes:
a first link;
a second link;
the motor configured to displace the second link with respect to the first link;
the motor control unit configured to control the motor;
a first heat dissipation member;
a second heat dissipation member;
a first heat conduction member configured to connect the motor control unit and the first heat dissipation member to each other, and
a second heat conduction member configured to connect the motor and the second heat dissipation member to each other, and
wherein the first heat conduction member and the second heat conduction member are separated from each other, and the first heat dissipation member and the second heat dissipation member are separated from each other.

21. A non-transitory computer-readable recording medium storing a program for causing the motor control unit to execute the control method according to claim 20.

22. A method for manufacturing an article, the method comprising:
controlling the robot according to claim 1 to perform article manufacturing work.

23. The method for manufacturing the article according to claim 22,
wherein the article manufacturing work includes at least one of component conveyance work, component assembly work, component processing work, and component cleaning work.

24. A drive device for relatively displacing a first link and a second link, the drive device comprising:
a motor configured to displace the second link with respect to the first link;
a motor control unit configured to control the motor;
a first heat dissipation member;
a second heat dissipation member,
a first heat conduction member configured to connect the motor control unit and the first heat dissipation member to each other, and
a second heat conduction member configured to connect the motor and the second heat dissipation member to each other,
wherein the first heat conduction member and the second heat conduction member are separated from each other, and the first heat dissipation member and the second heat dissipation member are separated from each other.

25. A control method of a drive device for relatively displacing a first link and a second link, the method comprising: controlling a motor by a motor control unit,
wherein the drive device includes:
the motor configured to displace the second link with respect to the first link;
the motor control unit configured to control the motor,
a first heat dissipation member;
a second heat dissipation member;
a first heat conduction member configured to connect the motor control unit and the first heat dissipation member to each other; and
a second heat conduction member configured to connect the motor and the second heat dissipation member to each other, and
wherein the first heat conduction member and the second heat conduction member are separated from each other, and the first heat dissipation member and the second heat dissipation member are separated from each other.
